(19) United States
(12) Patent Application Publication
(10) Pub. No.: US 2025/0309382 A1
(43) Pub. Date: Oct. 2, 2025

(54) POWER STORAGE DEVICE AND CONTROL METHOD

(71) Applicant: HONDA MOTOR CO., LTD., Tokyo (JP)

(72) Inventors: Pu Qian, Wako-shi (JP); Wataru Hoshikawa, Wako-shi (JP); Takaharu Watanabe, Wako-shi (JP); Kota Ogasawara, Wako-shi (JP); Shiori Nakanishi, Wako-shi (JP)

(21) Appl. No.: 19/058,044

(22) Filed: Feb. 20, 2025

(30) Foreign Application Priority Data
Mar. 29, 2024 (JP) 2024-057705

(51) Int. Cl. H01M 10/44; B60L 58/13; B60L 58/22; H01M 10/0525; H02J 7/00; H02J 7/34

(52) U.S. Cl. CPC H01M 10/441; B60L 58/13; B60L 58/22; H01M 10/0525; H02J 7/0013; H02J 7/00714; H02J 7/007182; H02J 7/342

(57) ABSTRACT

A control method for controlling a power storage device including a lithium metal battery includes performing control to charge the lithium metal battery at a rate of 0.2 C or less and to discharge the lithium metal battery at a rate of 1.0 C or more and 2.0 C or less.

### CROSS-REFERENCE TO RELATED APPLICATION

Priority is claimed on Japanese Patent Application No. 2024-057705, filed Mar. 29, 2024, the content of which is incorporated herein by reference.

### BACKGROUND OF THE INVENTION

### Field of the Invention

The present invention relates to a power storage device and a control method.

### Description of Related Art

In recent years, to allow more people to secure access to reasonably reliable, sustainable, and advanced energy, secondary batteries that contribute to energy efficiency are under research and development. Patent Document 1 describes an invention regarding charging/discharging management for the purpose of suppressing deterioration of a battery using a secondary battery in a mobility. In improving a cruising range of the mobility, it is effective to utilize a high-capacity density secondary battery. Patent Document 2 discloses a method for controlling an electric vehicle using a secondary battery. Patent Document 2 discloses a metal lithium battery that is a high-capacity density battery and uses metal lithium in a negative electrode, as a usable secondary battery.

[Patent Document 1] Japanese Unexamined Patent Application, First Publication No. 2023-120237

[Patent Document 2] Japanese Unexamined Patent Application, First Publication No. 2023-38288

### SUMMARY OF THE INVENTION

In a technique regarding a secondary battery, it is desirable to secure safety and maintain a high cruising range even in a case where an electrified vehicle is used for a long period. In a lithium metal battery (LMB), a layer of inactive lithium metal is formed on a surface of metal lithium to be as a negative electrode according to charging/discharging. If the layer of inactive lithium metal is formed, a battery capacity is reduced, and cycle characteristics are deteriorated. In the lithium metal battery, if the layer of inactive lithium metal is formed, the thickness of a battery cell increases.

An object of an aspect according to the present invention is to secure safety and achieve maintenance of a high cruising range even in a case where an electrified vehicle is used for a long period, by improvement of cycle characteristics. The present invention contributes to energy efficiency.

To solve the above-described problems and achieve the objects, the present invention employs the following aspects.
(1) A control method according to an aspect of the present invention is a control method for controlling a power storage device including a lithium metal battery, the control method including performing control to charge the lithium metal battery at a rate of 0.2 C or less and to discharge the lithium metal battery at a rate of 1.0 C or more and 2.0 C or less.
(2) In the aspect of (1) described above, the lithium metal battery may be charged according to a charging resistance after discharging.
(3) In the aspect of (1) described above, the power storage device may include a first battery that is a lithium metal battery, and a second battery that is a secondary battery other than a lithium metal battery, and electric power supply from the second battery to the first battery may be performed during discharging from the power storage device.
(4) In the aspect of (3) described above, the electric power supply from the second battery to the first battery may be performed at a rate of 0.2 C or less.
(5) In the aspect of (1) described above, the power storage device may include a first battery that is a lithium metal battery, and a third battery that is a secondary battery other than a lithium metal battery, and during charging of the power storage device, the first battery may be charged at a rate of 0.2 C or less, and the third battery may be charged at a rate exceeding 0.2 C.
(6) In the aspect of (1) described above, the power storage device may include a first battery that is a lithium metal battery, and a second battery and a third battery that are a secondary battery other than a lithium metal battery, the second battery may have a higher capacity density than that of the third battery, the third battery may have a higher output density than that of the second battery, during charging of the power storage device, a charging rate of the first battery may be 0.2 C or less, a charging rate of the second battery may be a rate exceeding 0.2 C, a charging rate of the third battery may be higher than the charging rate of the second battery, and during discharging from the power storage device, electric power supply from the second battery to the first battery may be performed.
(7) In the aspect of (5) or (6) described above, the power storage device may be mounted in an electrified vehicle and may supply regenerative electric power to the third battery.
(8) A power storage device according to an aspect of the present invention includes a plurality of battery blocks including an LMB block composed of a plurality of lithium metal battery cells, in which each battery block is configured to be attachable and detachable.
(9) In the aspect of (8) described above, a plurality of LMB blocks may be provided.
(10) In the aspect of (8) described above, a second battery block composed of a secondary battery cell other than lithium metal may be provided.
(11) In the aspect of (10) described above, the LMB block and the second battery block may be configured to be electrically connectable.

According to the aspect of (1) described above, during charging/discharging of the lithium metal battery, it is possible to reduce a rate of forming a layer of a lithium inactive material on negative electrode lithium metal, to secure safety, and to improve the cycle characteristics of the power storage device.

According to the aspect of (2) described above, it is possible to smooth a lithium inactive material by removing the lithium inactive material likely to be formed on a negative electrode in a dendrite shape during charging, from the negative electrode by discharging before charging, to prevent a locally thick lithium inactive material from being formed on the negative electrode during charging, and to improve the cycle characteristics.

According to the aspects of (3) to (5) described above, it is possible to increase the SOC of the entire power storage device over a long period, and to improve a charging time and a charging frequency as well as to improve the cycle characteristics by charging a lithium metal battery that has a limited charging rate but exhibits a high capacity from a viewpoint of preventing formation of a lithium inactive material, at a charging rate with which lithium inactive material growth is able to be prevented and performing adjustment to decrease an SOC of a battery that is charged with a high charging rate during charging, other than the lithium metal battery.

According to the aspect of (6) described above, during charging, it is possible to preferentially charge a battery with which a charging rate is able to be increased, to cover a difference between a discharging rate and a charging rate of a suitably usable lithium metal battery in which the charging rate and the discharging rate deviate from each other, to increase the SOC of the entire power storage device as well as to improve the cycle characteristics, and to improve the charging time and the charging frequency.

According to the aspect of (7) described above, it is possible to increase the SOC of the entire power storage device for a long term by supplying regenerative electric power to a battery with a high battery capacity.

According to the aspects of (8) and (9) described above, even in a case where the cycle characteristics of the lithium metal battery among a plurality of battery blocks are deteriorated due to long-term use, it is possible to maintain a high cruising range with the replacement of the battery.

According to the aspects of (10) and (11) described above, it is possible to charge and discharge a lithium metal battery having a charging rate and a discharging rate for maintaining excellent cycle characteristics during charging/discharging at a suitable rate, to charge and discharge the second battery at a rate higher than the lithium metal battery, and to increase the SOC of the entire power storage device over a long period.

### BRIEF DESCRIPTION OF THE DRAWINGS

FIG. 1 is a block diagram schematically illustrating a configuration of an electrified vehicle in which a power storage device according to an embodiment of the present invention is mounted.

FIG. 2 is a circuit diagram illustrating a control method during charging for the power storage device of FIG. 1.

FIG. 3 is a circuit diagram illustrating a control method during discharging for the power storage device of FIG. 1.

FIG. 4 is a block diagram illustrating the control method during discharging in the power storage device of FIG. 1.

FIG. 5 is a circuit diagram illustrating a control method during charging for a power storage device according to a modification example of FIG. 2.

FIG. 6 is a circuit diagram illustrating a control method during discharging for the power storage device according to the modification example of FIG. 2.

FIG. 7 is a circuit diagram illustrating a control method during charging for a power storage device according to another modification example of FIG. 2.

FIG. 8 is a circuit diagram illustrating a control method during discharging for the power storage device according to another modification example of FIG. 2.

FIG. 9 is a graph illustrating a capacity retention of a lithium metal battery under charging/discharging conditions in each of Example 1 and Comparative Example 1.

### DETAILED DESCRIPTION OF THE INVENTION

Hereinafter, an embodiment of the present invention will be described with reference to the drawings.

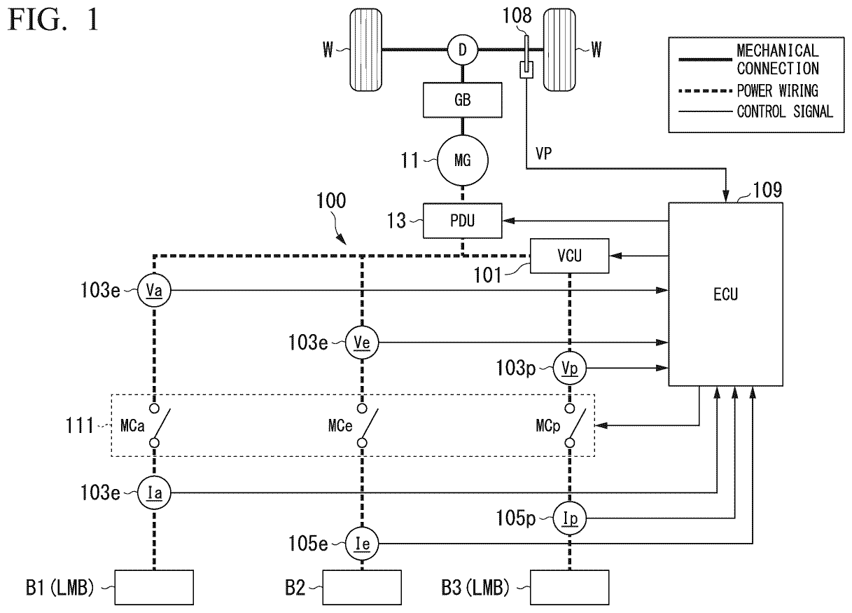

FIG. 1 is a block diagram schematically illustrating a configuration of an electrified vehicle in which a power storage device according to an embodiment of the present invention is mounted. A thick solid line in FIG. 1 indicates mechanical connection, a two-dot-chain line indicates power wiring, and a thin solid-line indicates a control signal. A 1 MOT type electrified vehicle illustrated in FIG. 1 includes a motor generator (MG) 11, a power drive unit (PDU) 13, and a power storage device 100 of an embodiment. Hereinafter, each component in the electrified vehicle will be described.

The power storage device 100 includes battery blocks including a lithium metal battery. In an example illustrated in FIG. 1, an electrified vehicle in which the power storage device 100 including battery blocks B1 to B3 composed of lithium metal battery cells is mounted will be described. In FIG. 1, while an example where the power storage device 100 in which the number of battery blocks is three will be described, the number of battery blocks will not be limited as long as a plurality of battery blocks composed of a lithium metal battery cell are provided. For example, the number of battery blocks in the power storage device may be four or more.

The motor generator 11 is driven with electric power supplied from the power storage device 100, and generates power for traveling of the electrified vehicle. Torque generated by the motor generator 11 is transmitted to drive wheels W via a gear box GB including a variable transmission or a fixed transmission and a differential gear D. The motor generator 11 operates as a generator during deceleration of the electrified vehicle to output a braking force of the electrified vehicle. Regenerative electric power generated by operating the motor generator 11 as a generator is stored in a battery of the power storage device 100.

The PDU 13 converts a direct-current voltage into an alternating-current voltage to supply a three-phase current to the motor generator 11. The PDU 13 converts an alternating-current voltage input during a regenerative operation of the motor generator 11 into a direct-current voltage.

The power storage device 100 includes, as illustrated in FIG. 1, a plurality of battery blocks B1 to B3, a voltage control unit (VCU) 101, voltage sensors 103p, 103e, and 103a, current sensors 105p, 105e, and 105a, a vehicle speed sensor 108, a switch unit 111, an electronic control unit (ECU) 109, and an accelerator position sensor (APS) (not illustrated). Each of the battery blocks B1 to B3 is attachably and detachably mounted in the power storage device 100. Each of the battery blocks B1 to B3 has a plurality of battery cells.

The battery blocks B1 to B3 are, for example, battery blocks composed of a plurality of lithium metal battery cells. The lithium metal battery cell is a battery that uses one or both of lithium metal and a lithium alloy in a negative electrode. The lithium alloy is an alloy of lithium, any element selected from a group consisting of magnesium, aluminum, and indium, and inevitable impurities, and an alloy in which a content of lithium is equal to or greater than 90% and less than 100% can be used. A content of inevitable impurities in an aluminum alloy is equal to or less than 0.05% by mass.

It is preferable that the plurality of battery blocks B1 to B3 are electrically connected to each other. The plurality of battery blocks B1 to B3 are electrically connected to each other, the battery blocks B1 to B3 can supply electric power to each other during discharging such as during traveling of the electrified vehicle.

The VCU 101 boosts output voltages of the battery blocks B1 to B3 as a direct current. The VCU 101 steps down electric power generated by the motor generator 11 and converted into a direct current during deceleration of the electrified vehicle. The VCU 101 steps down the output voltages of the battery blocks B1 to B3 as a direct current. The electric power stepped down by the VCU 101 is charged in, for example, the battery blocks B1 to B3. A voltage level or a current level of the direct-current power output from the VCU 101 is controlled by the ECU 109.

The voltage sensor 103a detects a voltage Va of the battery block B1. A signal indicating the voltage Va detected by the voltage sensor 103a is sent to the ECU 109. The voltage sensor 103e detects a voltage Ve of the battery block B2. A signal indicating the voltage Ve detected by the voltage sensor 103e is sent to the ECU 109. The voltage sensor 103p detects a voltage Vp of the battery block B3. A signal indicating the voltage Vp detected by the voltage sensor 103p is sent to the ECU 109.

When each of the battery blocks B1 to B3 is in an open state, the voltages Va, Ve, and Vp are an open circuit voltage (OCV), and the voltage Va detected by the voltage sensor 103a, the voltage Ve detected by the voltage sensor 103e, and the voltage Vp detected by the voltage sensor 103p, acquired by the ECU 109, and the battery block B1, the battery block B2, and the battery block B3 have a prescribed relationship, and a map is acquired in advance. The ECU 109 can derive a stage of charge of each of the battery blocks B1 to B3 from the acquired voltages Va, Ve, and Vp on the basis of the map.

The current sensor 105a detects an input/output current Ia of the battery block B1. A signal indicating the input/output current Ia detected by the current sensor 105a is sent to the ECU 109. The current sensor 105e detects an input/output current Ie of the battery block B2. A signal indicating the input/output current Ie detected by the current sensor 105e is sent to the ECU 109. The current sensor 105p detects an input/output current Ip of the battery block B3. A signal indicating the input/output current Ip detected by the current sensor 105p is sent to the ECU 109.

The vehicle speed sensor 108 detects a traveling speed (vehicle speed) VP of the electrified vehicle. A signal indicating the vehicle speed VP detected by the vehicle speed sensor 108 is sent to the ECU 109.

The switch unit 111 has a contactor MCa that connects and disconnects a current path from the battery block B1 to the PDU 13 or the VCU 101, a contactor MCe that connects and disconnects a current path from the battery block B2 to the VCU 101, and a contactor MCp that connects and disconnects a current path from the battery block B3 to the VCU 101. Each of the contactors MCa, MCe, and MCp is opened and closed under the control of the ECU 109.

The ECU 109 controls the PDU 13 and the VCU 101, and controls opening and closing of the switch unit 111. The ECU 109 determines a traveling state of the electrified vehicle on the basis of the vehicle speed VP indicated by the signal acquired from the vehicle speed sensor 108. When determination is made that the electrified vehicle is not in the traveling state, the ECU 109 controls the PDU 13 such that all switching elements of the PDU 13 are brought into an off state, and controls the VCU 101 such that all switching elements of the VCU 101 are brought into an off state. With such control, each is brought into a state of an open circuit.

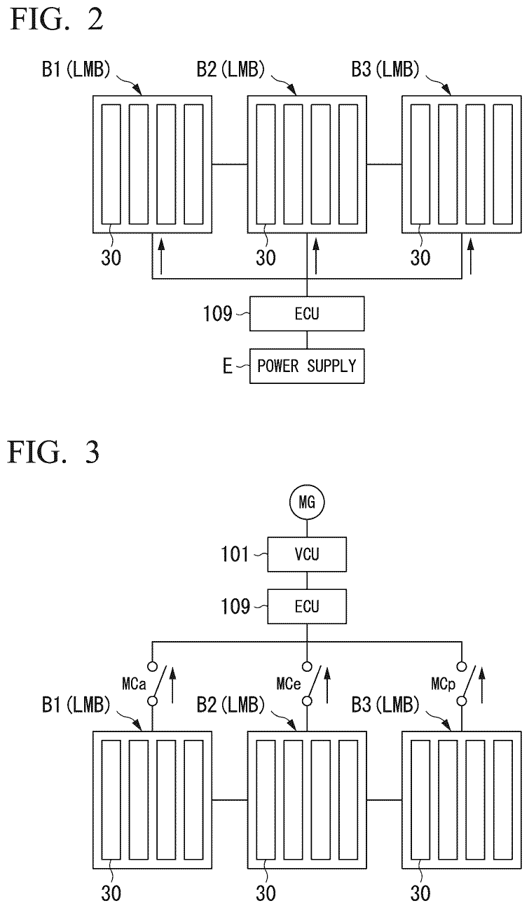

FIG. 2 is a circuit diagram illustrating a control method during charging for the power storage device 100 of FIG. 1, and extracts and illustrates the ECU 109 and a portion of the power storage device 100 including the battery blocks B1 to B3. The power storage device 100 includes a plurality of battery blocks B1 to B3. The plurality of battery blocks B1 to B3 in the power storage device 100 are connected in parallel. The battery blocks B1 to B3 are an LMB block composed of lithium metal battery cells 30.

In FIG. 2, for convenience of description, electric power supplied from a power supply to each of the battery blocks B1 to B3 is indicated by an arrow. If the electrified vehicle is connected to an external power supply E such as a power supply station, the ECU 109 controls charging such that charging rates of the battery blocks B1 to B3 are 0.2 C or less. The control of the charging rate is performed, for example, by the ECU 109 calculating a current necessary for each block, instructing a total current value to the external power supply E, and distributing the current input from the external power supply E to each block according to the calculated value.

It is preferable that, in charging, the battery blocks B1 to B3 are discharged in advance. It is preferable that a discharging rate in this case is 1.0 C or more. The lithium metal battery is rapidly discharged before charging, so that it is possible to smooth a lithium inactive material by removing the lithium inactive material likely to be formed in a dendrite shape on a negative electrode during charging, from the negative electrode by discharging before charging, and to prevent a locally thick lithium inactive material from being formed on the negative electrode during charging. In the rapid discharging, under a constraint condition that a discharging rate per LMB block is a rate of 1.0 C or more and 2.0 C or less by opening and closing of the contactors connected in series to the battery blocks B1 to B3, the number of battery blocks is selected, and discharging is performed.

Discharging of the lithium metal battery before charging is performed, for example, according to a charging resistance of the lithium metal battery. It is considered that, when the charging resistance is high, a layer of precipitated inactive lithium metal is thickened, and the lithium inactive material formed in the dendrite shape is likely to cause short-circuit compared to when the charging resistance is low. For this reason, it is preferable that discharging is performed before charging. In this way, in charging, it is preferable to measure the charging resistance and to identify whether to perform rapid discharging according to the charging resistance of the lithium metal battery, as an identification step.

The ECU 109 confirms a charging/discharging capacity C of the battery block by performing constant current control on each battery block for a time Δt, and when the charging/discharging C is identified to be equal to or less than a prescribed value, can display a signal to a meter panel or the like to detach the battery block and attach a new battery block.

In this processing, the charging/discharging capacity C can be calculated by ΔAh/ΔSOC. ΔAh is a product of a constant current Ic and a time Δt. ΔSOC is a difference between SOC(t+Δt) and SOC(t). SOC(t) is the SOC of the battery block immediately before charging/discharging by constant current control is performed. SOC(t+Δt) is the SOC of the battery block immediately after charging/discharging by constant current control is performed. That is, the charging/discharging capacity C is represented by the following expression.

C=ΔAh/ΔSOC=[(Ic×Δt)/{SOC(t+Δt)−SOC(t)}

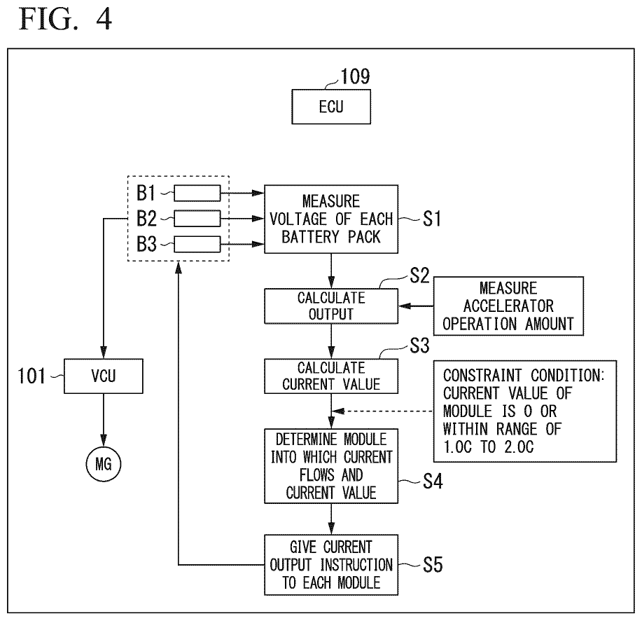

FIG. 3 is a circuit diagram illustrating a control method during discharging for the power storage device 100 of FIG. 1, and extracts and illustrates a portion of the ECU 109 and the power storage device 100 including the battery blocks B1 to B3. FIG. 4 is a block diagram illustrating the control method during discharging in the power storage device of FIG. 1.

During discharging, the ECU 109 first acquires the voltage Va of the battery block B1 detected by the voltage sensor 103a, the voltage Ve of the battery block B2 detected by the voltage sensor 103e, and the voltage Vp of the battery block B3 detected by the voltage sensor 103p (Step S1).

Next, an output corresponding to a load is calculated by measuring an accelerator operation amount with the APS (Step S2).

Next, a current value flowing in each battery block when a combination of battery blocks to be used is adjusted is calculated from the voltages measured in Step S1 and the output calculated in Step S2 (Step S3).

Next, a combination of the battery blocks B1 to B3 in which a current flows and the current values are determined from a calculation result in Step S3 such that the current values of the battery blocks B1 to B3 including the lithium metal battery are at a discharging rate of 0 or 1.0 to 2.0 C (Step S4).

Next, the switch unit 111 is controlled such that opening and closing of the contactors MCa, MCe, and MCp correspond to the combination of the battery blocks in which the current flows, determined in Step S4, and a current output instruction is given to each of the battery blocks B1 to B3 (Step S5). The output current is subjected to voltage control by the VCU 101 and is then supplied to the motor generator 11 via the PDU 13.

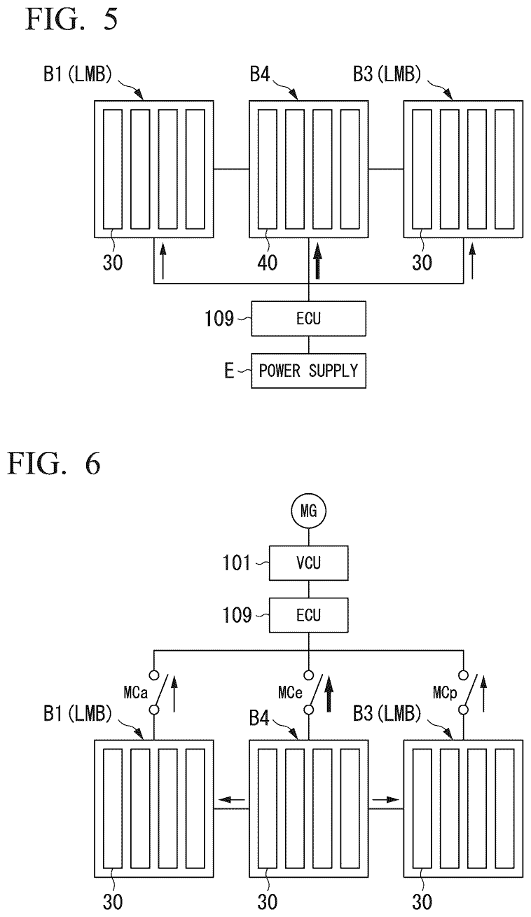

FIG. 5 is a circuit diagram illustrating a control method during charging for a power storage device according to a modification example of FIG. 2, and FIG. 6 is a circuit diagram illustrating a control method during discharging for the power storage device according to the modification example of FIG. 2. In FIGS. 5 and 6, a portion of the power storage device is extracted and illustrated. The power storage device of which a portion of an electric circuit is illustrated in FIGS. 5 and 6 is different from the power storage device 100 illustrated in FIGS. 1 to 3 in that a battery block B4 composed of battery cells 40 other than a lithium metal battery cell is provided in addition to the battery blocks B1 and B3 composed of lithium metal battery cells. Other configurations can be made similarly. Also in the power storage device illustrated in FIGS. 5 and 6, the SOC of each of the battery blocks B1, B2, and B4 can be derived similarly to the power storage device 100.

The battery block B4 has, for example, a plurality of storage cells such as a lithium-ion secondary battery or a nickel-hydrogen battery, instead of a configuration in which the negative electrode is made of lithium metal. In the present embodiment, the battery block B4 is also referred to as a second battery or a third battery. The battery block B4 is not limited to a secondary battery such as the lithium-ion battery or the nickel-hydrogen battery described above. For example, while a storage capacity is small, a capacitor capable of charging and discharging a large amount of electric power in a short time may be used. The battery block is also referred to as a battery module.

A lithium-ion secondary battery is divided into, for example, a high-output system lithium-ion secondary battery and a high-capacity system lithium-ion secondary battery. The high-output system lithium-ion secondary battery is a lithium-ion secondary battery in which an output density is high, but a capacity density is not so high. On the other hand, the high-capacity system lithium-ion secondary battery is a lithium-ion secondary battery in which a capacity density is high, but an output density is not so high.

The characteristics of the high-output system lithium-ion battery and the high-capacity system lithium-ion battery are different from each other. The high-output system lithium-ion secondary battery has a lower energy weight density and a higher output weight density than the high-capacity system lithium-ion battery, in the lithium-ion secondary battery. The high-capacity system lithium-ion secondary battery has a lower output weight density and a higher energy weight density than those of the high-output system lithium-ion secondary battery, in the lithium-ion secondary battery. In this way, the high-capacity system lithium-ion secondary battery is relatively excellent in terms of the energy weight density, and the high-output system lithium-ion secondary battery is relatively excellent in terms of the output weight density. The energy weight density is an electric power amount (Wh/kg) per unit weight, and the output weight density is electric power (W/kg) per unit weight. An example of the high-output system lithium-ion secondary battery is a lithium-ion secondary battery in which graphite, hard carbon, or a lithium titanium oxide (LTO) is used in the negative electrode.

In the control of the power storage device according to the modification example, similar control to the above-described charging/discharging can also be performed.

The charging rate and the discharging rate may be adjusted considering that the battery block B4 has characteristics different from the battery blocks B1 to B3. For example, in the lithium-ion secondary battery, in particular, the high-output system lithium-ion secondary battery, even in a case where charging is performed at a charging rate exceeding 0.2 C, deterioration of the cycle characteristics has not been confirmed.

In this case, since the battery blocks having different characteristics are provided in the power storage device, the ECU 109 performs electric power distribution control using the VCU 101 to take advantage of the characteristics of each of the battery blocks B1 and B3 and the battery block B4 having different characteristics.

For example, in charging, the battery block B4 is controlled to be preferentially charged. Specifically, the battery blocks B1 and B3 are charged at 0.2 C or less, and the battery block B4 is charged at a rate exceeding 0.2 C. It is more preferable that the battery block B4 is charged at a rate exceeding 1.0 C. With such electric power distribution control, it is possible to increase the state of charge (SOC) of the entire power storage device even for a short charging time.

It is preferable that the regenerative electric power generated by the motor generator 11 is preferentially input to the battery block B4, is input only to the battery block B4, or an input to the battery blocks B1 and B3 is performed at a rate of 0.2 C or less, and remaining electric power is input to the battery block B4.

During discharging, the ECU 109 can control the VCU 101 such that discharging of the battery blocks B1 and B3 is performed at a discharging rate of 1.0 C or more and 2.0 C or less by a similar control method to the above-described embodiment, and discharging of the battery block B4 is performed at a discharging rate higher than that of the battery blocks B1 and B3.

In a case where the battery block B4 is composed of lithium-ion secondary battery cells, it is preferable that the battery blocks B1, B3, and B4 are electrically connected, and electric power is controlled to be supplied from the battery block B4 to one or both of the battery blocks B1 and B3 at a rate of 0.2 C or less. The ECU can perform electric power supply from the battery block B4 to one or both of the battery blocks B1 and B3 via a booster circuit. The electric power supply from the battery block B4 to the battery blocks B1 and B3 is performed when the SOC of the battery block B4 is equal to or greater than a prescribed value and the SOC of the battery blocks B1 and B3 is equal to or less than 50%, and is not performed when the condition is not satisfied. The prescribed value of the SOC of the battery block B4 can be set to, for example, 30% or more, and is preferably set to 50%.

The electric power is supplied from the battery block B4 to the battery blocks B1 and B3 composed of the lithium metal battery cells 30 at a rate of 0.2 C or less, so that the lithium metal battery cells can be charged within a range causing less deterioration of the cycle characteristics.

Since the SOC of the battery block B4 can be reduced without changing the SOC of the entire power storage device, the battery block B4 can be preferentially charged with external electric power at a charging station or the like, and charging can be performed with greater electric power in a short time, it is possible to increase the SOC of the entire power storage device over a long period, and to improve a charging time and a charging frequency as well as to improve the cycle characteristics. In the battery block composed of the lithium metal battery cells, in a case where charging is performed at a charging rate of 0.2 C or less, charging for about five hours is required; however, with such control, the charging time can be reduced, and high marketability can be secured.

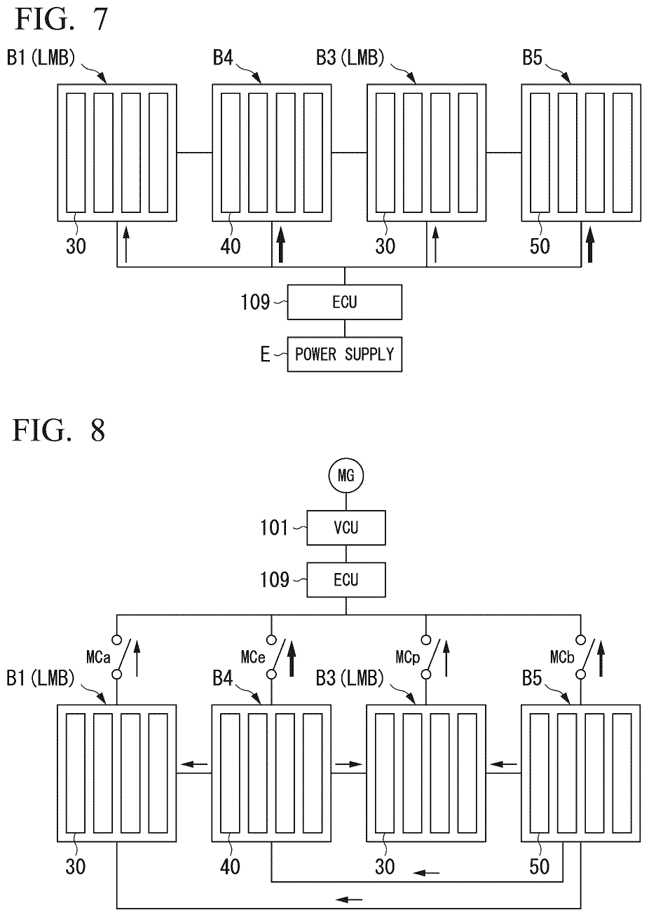

FIG. 7 is a circuit diagram illustrating a control method during charging for a power storage device according to another modification example of FIG. 2. FIG. 8 is a circuit diagram illustrating a control method during discharging for the power storage device according to another modification example of FIG. 2. In the example illustrated in FIGS. 7 and 8, a battery block B4 is a battery block composed of high-output system lithium-ion secondary battery cells 40, and a battery block B5 is a battery block composed of high-capacity system lithium-ion secondary battery cells 50. In the present embodiment, while a lithium-ion battery of any of a high-output system and a high-capacity system can be used as a second battery or a third battery, the battery block B5 composed of the high-capacity system lithium-ion secondary battery cells 50 is preferably used as the second battery, and the battery block B4 composed of the high-output system lithium-ion secondary battery cells 40 is preferably used as the third battery.

In the power storage device of which a portion of an electric circuit is illustrated in FIGS. 7 and 8, charging/discharging can also be performed by a similar control method to the above-described embodiment. The electric power distribution control using the VCU 101 is performed to take advantage of the characteristics of each of the battery blocks B1 and B3 and the battery blocks B4 and B5 having different characteristics.

During charging, the ECU 109 performs control such that electric power is more preferentially supplied to the battery blocks B4 and B5 than the battery blocks B1 and B3. The ECU 109 performs control such that the battery blocks B1 and B3 are charged at a charging rate of 0.2 C or less, and performs control such that the battery blocks B4 and B5 are charged at a charging rate exceeding 0.2 C.

During discharging, the ECU 109 can control the VCU 101 such that the discharging of the battery blocks B1 and B3 is performed at a discharging rate of 1.0 C or more and 2.0 C or less by a similar method to the above-described embodiment, and a discharging rate of the battery blocks B4 and B5 is a rate higher than that of the battery blocks B1 and B3. The ECU 109 controls the VCU such that the discharging rate of the battery block B4 is higher than the discharging rate of the battery block B5. Here, the battery blocks B1, B3, B4, and B5 are electrically connected, and it is preferable that electric power is controlled to be supplied from the battery block B4 to one or both of the battery blocks B1 and B3 at a rate of 0.2 C or less. Similarly, it is preferable that electric power is controlled to be supplied from the battery block B5 to one or both of the battery blocks B1 and B3 at a rate of 0.2 C or less. It is preferable that electric power is also supplied from the battery block B5 composed of the high-capacity system lithium-ion secondary battery cells 50 to the battery block B4 composed of the high-output system lithium-ion secondary battery cells 40. The electric power supply from the battery block B4 to the battery blocks B1 and B3 is performed when the SOC of the battery block B4 is equal to or greater than a prescribed value, and the SOC of the battery blocks B1 and B3 is equal to or less than 50%, and is not performed when the condition is not satisfied. The prescribed value can be set to, for example, 30%, and is preferably set to 50%. Similarly, the electric power supply from the battery block B5 to the battery blocks B1 and B3 is performed when the SOC of the battery block B5 is equal to or greater than a prescribed value, and is not performed when the SOC of the battery block B5 is less than the prescribed value. The prescribed value can be set to, for example, 30%, and is preferably set to 50%.

The electric power is supplied between the battery blocks in the power storage device within a range of a prescribed rate, so that it is possible to set the SOC balance of the battery blocks in the power storage device to a suitable value, resulting in the reduction of the charging frequency, the reduction of the charging time, and lifetime improvement of the lithium metal battery.

In the power storage device of which a portion of the circuit diagram is illustrated in FIGS. 7 and 8, it is preferable that the regenerative electric power is preferentially input to the battery block B4, is input only to the battery block B4, is input only to the battery block B4 and the battery block B5, or an input to the battery blocks B1 and B3 is performed at a rate of 0.2 C or less, an input to the battery block B5 is performed at a rate of 0.5 C or less, and remaining electric power is input to the battery block B4.

While the present invention has been described with the embodiment, the technical scope of the present invention is not limited to the above-described embodiment. It is apparent to persons skilled in the art that various alterations or improvements can be added to the above-described embodiment. It is also apparent that the embodiment added with such alterations or improvements can be included in the technical scope of the present invention.

### EXAMPLE

Hereinafter, while the present invention will be further specifically described with an example, the present invention is not limited to the following example.

An electrolyte of lithium salt containing fluorine was used, and a lithium metal battery cell having a negative electrode made of lithium metal was produced.

### Example 1

As Example 1, an electric capacity of a lithium metal battery when charging and discharging with charging at a charging rate of 0.2 C and discharging at a discharging rate of 1.0 C as one cycle were repeated for the lithium metal battery cell in an environment of 25°0 C. was measured. A capacity retention at every five cycles of the lithium metal battery when an electric capacity after one cycle was 100% was calculated.

### Comparative Example 1

Excluding that the charging rate was changed to 0.33 C, and the discharging rate was changed to 0.33 C, similarly to Example 1, a capacity retention at every five cycles of the lithium metal battery was calculated.

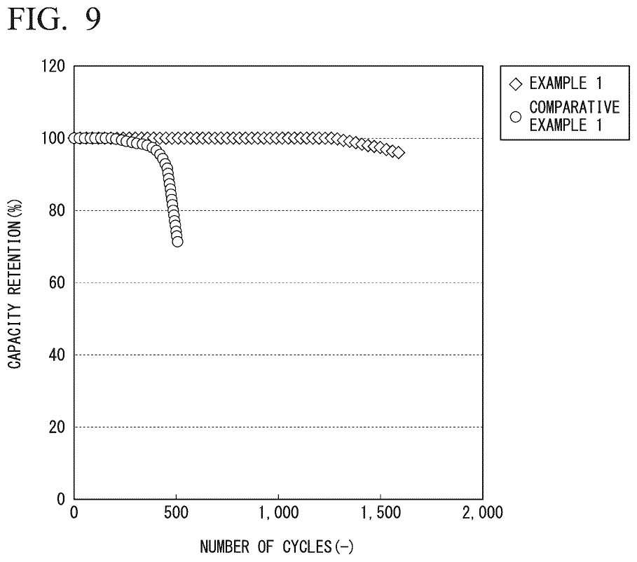

FIG. 9 is a graph illustrating a capacity retention of a lithium metal battery under charging/discharging conditions in each of Example 1 and Comparative Example 1.

As illustrated in FIG. 9, in a case where charging and discharging were performed at the charging rate of 0.2 C or less and the discharging rate of 1.0 C or more and 2.0 C or less, it was confirmed that the cycle characteristics were excellent, compared to a case where charging and discharging were performed under the condition of the charging rate exceeding 0.2 C and the discharging rate less than 1.0 C. From this result, it was confirmed that the battery lifetime could be significantly improved and the cruising range could be increased by controlling the battery block composed of the lithium metal battery cells to be charged at a rate of 0.2 C or less and to be discharged at a rate of 1.0 C or more and 2.0 C or less.

What is claimed is:

1. A control method for controlling a power storage device including a lithium metal battery, the control method comprising:
performing control to charge the lithium metal battery at a rate of 0.2 C or less and to discharge the lithium metal battery at a rate of 1.0 C or more and 2.0 C or less.

2. The control method according to claim 1,
wherein the lithium metal battery is charged according to a charging resistance after discharging.

3. The control method according to claim 1,
wherein the power storage device includes a first battery that is a lithium metal battery, and a second battery that is a secondary battery other than a lithium metal battery, and
electric power supply from the second battery to the first battery is performed during discharging from the power storage device.

4. The control method according to claim 3,
wherein the electric power supply from the second battery to the first battery is performed at a rate of 0.2 C or less.

5. The control method according to claim 1,
wherein the power storage device includes a first battery that is a lithium metal battery, and a third battery that is a secondary battery other than a lithium metal battery, and
during charging of the power storage device, the first battery is charged at a rate of 0.2 C or less, and the third battery is charged at a rate exceeding 0.2 C.

6. The control method according to claim 1,
wherein the power storage device includes a first battery that is a lithium metal battery, and a second battery and a third battery that are a secondary battery other than a lithium metal battery,
the second battery has a higher capacity density than that of the third battery,
the third battery has a higher output density than that of the second battery,
during charging of the power storage device, a charging rate of the first battery is 0.2 C or less, a charging rate of the second battery is a rate exceeding 0.2 C, and a charging rate of the third battery is higher than the charging rate of the second battery, and
during discharging from the power storage device, electric power supply from the second battery to the first battery is performed.

7. The control method according to claim 5,
wherein the power storage device is mounted in an electrified vehicle and supplies regenerative electric power to the third battery.

8. A power storage device comprising:
a plurality of battery blocks including an LMB block composed of a plurality of lithium metal battery cells,
wherein each battery block is configured to be attachable and detachable.

9. The power storage device according to claim 8,
wherein a plurality of LMB blocks are provided.

10. The power storage device according to claim 8,
wherein a second battery block composed of a secondary battery cell other than lithium metal is provided.

11. The power storage device according to claim 10,
wherein the LMB block and the second battery block are configured to be electrically connectable.
